(19) United States
(12) Patent Application Publication
(10) Pub. No.: US 2024/0048911 A1
(43) Pub. Date: Feb. 8, 2024

(54) GRAIN BOUNDARY DIFFUSION FOR HIGH COERCIVITY MAGNETS FOR LOUDSPEAKERS

(71) Applicant: Bose Corporation, Framingham, MA (US)

(72) Inventors: Stephen J. Maguire, Grafton, MA (US); Timothy M. Parker, Marlborough, MA (US)

(21) Appl. No.: 17/882,002

(22) Filed: Aug. 5, 2022

(51) Int. Cl. H04R 9/02; H04R 7/04; H01F 1/153

(52) U.S. Cl. CPC H04R 9/025; H04R 7/04; H01F 1/15325

(57) ABSTRACT

An electro-acoustic transducer includes a diaphragm and an electro-magnetic motor for driving motion of the diaphragm. The electro-magnetic motor includes a magnetic circuit that includes a first Rare earth-Iron-Boron (REFeB) magnet. The REFeB magnet includes a major phase and a grain boundary rich rare earth phase. A heavy rare earth element (HREE) is diffused into the first REFeB magnet through the grain boundary rich rare earth phase.

### BACKGROUND

This disclosure relates to grain boundary diffusion for high coercivity magnets for loudspeakers. In particular, this disclosure relates to the use of grain boundary diffusion for providing high coercivity Rare earth magnets for microdrivers.

### SUMMARY

All examples and features mentioned below can be combined in any technically possible way.

In one aspect, an electro-acoustic transducer includes a diaphragm and an electro-magnetic motor for driving motion of the diaphragm. The electro-magnetic motor includes a magnetic circuit that includes a first Rare earth-Iron-Boron (REFeB) magnet. The REFeB magnet includes a major phase and a grain boundary rich rare earth phase. A heavy rare earth element (HREE) is diffused into the first REFeB magnet through the grain boundary rich rare earth phase.

Implementations may include one of the following features, or any combination thereof.

In some implementations, the heavy rare earth element is selected from: Dysprosium (Dy) and Terbium (Tb).

In certain implementations, the first REFeB magnet includes one or more light rare earth elements selected from: Cerium (Ce), Neodymium (Nd) and Praseodymium (Pr).

In some cases, the major phase includes a plurality of grains and wherein the grains are substantially free of the HREE.

In certain cases, the magnetic circuit also includes a second REFeB magnet that includes a major phase and a grain boundary rich rare earth phase. A HREE is diffused into the second REFeB magnet through the grain boundary rich rare earth phase of the second REFeB magnet.

In some examples, the magnetic circuit includes a steel cup within which the first REFeB magnet is disposed and a steel coin disposed between the first REFeB magnet and the second REFeB magnet.

In certain examples, the first REFeB magnet is bonded to the steel cup with a first adhesive, the second REFeB magnet is bonded to the steel coin with a second adhesive, and the steel coin is bonded to the first REFeB magnet with a third adhesive.

In some implementations, the first, second and third adhesives may each be a thermally accelerated adhesive. In certain implementations, the first, second and third adhesives may all use the same adhesive material.

In some cases, a first surface of the first REFeB magnet is bonded to the steel cup and a second surface of the first REFeB magnet, opposite the first surface, is bonded to the steel coin.

In certain cases, the first REFeB magnet and the second REFeB magnet are bonded to opposite sides of the steel coin.

In some examples, the first REFeB magnet and the second REFeB magnet are arranged such that their magnetic fields are oriented opposite each other.

In certain examples, the second REFeB magnet has a surface area to volume ration (SA:V) of about 1 mm\hat{ }−1 to about 8 mm-1.

In some implementations, the first REFeB magnet has a surface area to volume ration (SA:V) of about 1 mm-1 to about 8 mm-1.

In certain implementations, the electro-acoustic transducer has an overall diameter of about 3 mm and about 16 mm.

In some cases, the diaphragm has a diameter of about 3 mm and about 16 mm.

In certain cases, the first REFeB magnet includes a Neodymium-Iron-Boron (NeFeB) magnet or a Cerium-Iron Boron (CeNdFeB) magnet (e.g., an NdFeB magnet in which a small amount of NdPr is replaced with Cerium).

### BRIEF DESCRIPTION OF THE DRAWINGS

FIG. 1A is a perspective view of a microdriver.

FIG. 1B is a cross-sectional perspective view of thereof.

FIG. 1C is a cross-sectional side view thereof.

FIG. 2A is a flowchart illustrating a method of manufacturing Rare earth-Iron-Boron (REFeB) magnets.

FIG. 2B is a flowchart illustrating a method of manufacturing REFeB magnets with the addition of a grain boundary diffusion processing step.

FIG. 2C is a flowchart illustrating an alternative method of manufacturing REFeB magnets with the addition of a grain boundary diffusion processing step.

FIG. 3A is a schematic representation of the microstructure of a REFeB magnet formed using the process of FIG. 2.

FIG. 3B is a schematic representation of the microstructure of a REFeB magnet formed using the process of FIG. 2 with the addition of a grain boundary diffusion processing step.

FIG. 4 is a plot of dipole moment measurements over temperature for 4 different versions of a secondary magnet from the microdriver of FIG. 1A.

FIG. 5 is a plot of dipole moment measurements over temperature for 4 different versions of a primary magnet from the microdriver of FIG. 1A.

Commonly labeled components in the FIGURES are considered to be substantially equivalent components for the purposes of illustration, and redundant discussion of those components is omitted for clarity. Numerical ranges and values described according to various implementations are merely examples of such ranges and values and are not intended to be limiting of those implementations. In some cases, the term “about” is used to modify values, and in these cases, can refer to that value +/−a margin of error, such as a measurement error, which may range from up to 1-5 percent.

### DETAILED DESCRIPTION

All Rare earth-Iron-Boron (REFeB) magnets are subject to demagnetization when exposed to high temperatures, e.g., in excess of 100° C. and reversed fields. This is particularly true for small magnets, for reasons that are discussed below. As a result of the heating processes used in motor assembly or normal use, the magnets could demagnetize, which would cause a loss of motor strength.

Another issue that contributes to a loss of motor strength is something we refer to as “small magnet syndrome.” Neodymium (Nd) Magnets are typically diamond ground, wire cut, or electrical discharge machining (EDM) machined to final shape from larger blocks. This machining process causes coercivity reduction damage to the surface of the magnet. The damage can occur to every surface that is so machined. This is not such a big deal with large magnets, because the volume to surface ratio is huge, but when very small magnets are manufactured, they all suffer from small magnet syndrome because their surface area is so high compared to the total volume of the finished magnets. Another thing that can damage the magnet surface coercivity is plating the magnets. These neodymium magnets also typically need to be plated to prevent corrosion and any kind of plating process also affects the surface layers of the magnets.

This disclosure relates to a new application of an existing process known as “grain boundary diffusion” (GBD) for reducing a magnet's sensitivity to temperature. GBD increases coercivity of magnets, which decreases their sensitivity to heat. The magnet industry developed GBD to address the issue of demagnetization in traction magnets used in electric vehicles. For EV magnets, the primary motivation for using grain boundary diffusion processes is a reduction in expensive heavy rare earth usage and to improve coercivity, without a corresponding loss of remanence due the heavy rare earth addition to the strip cast melt. The mechanisms for demagnetization in electric vehicle motors are different than in our speakers. In the electric vehicles, the motor itself operates at much higher temperatures during normal use and demagnetizing fields from the motor coils. The field from the coils in rotary motors push hard against the magnet's field. In our case, we need to contend with process temperature during manufacture, demagnetizing fields from two opposing magnets, and the effects of small magnet syndrome.

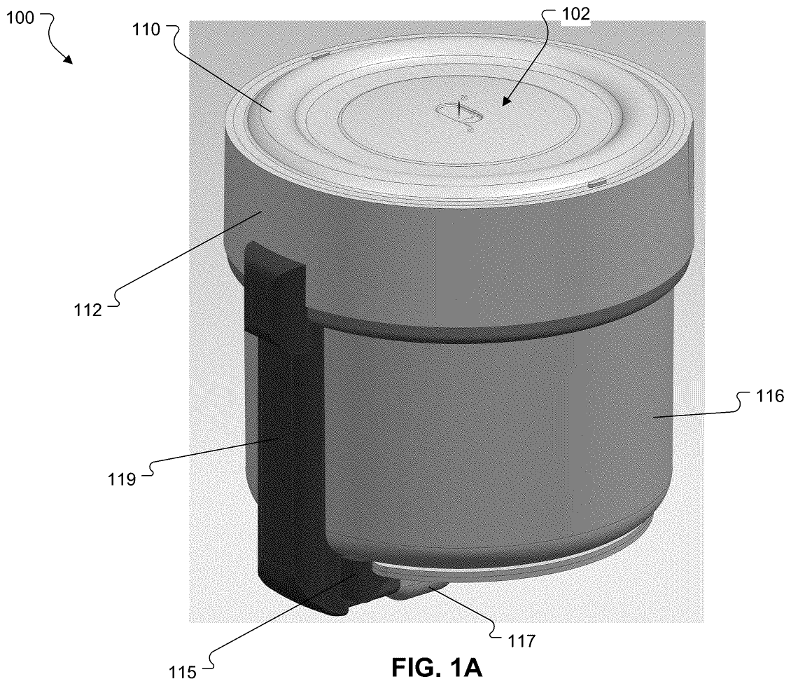

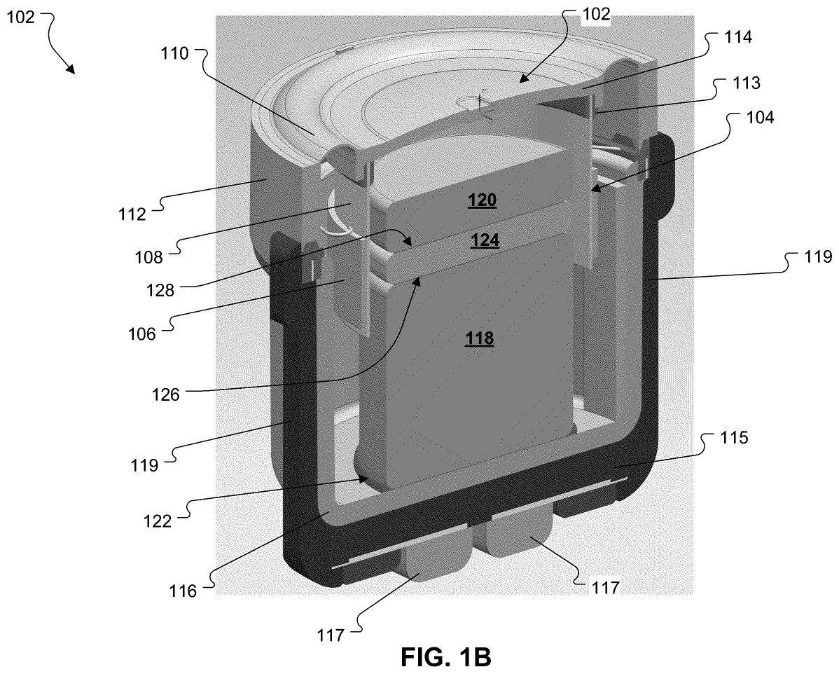

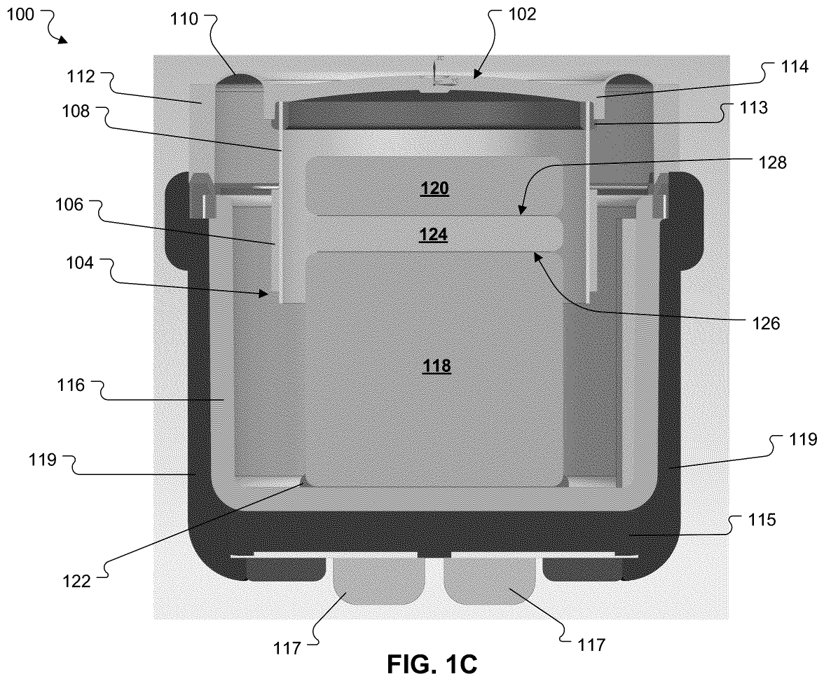

FIGS. 1A-1C illustrate an exemplary speaker 100 (a/k/a “electro-acoustic transducer” or “driver”). The speaker 100 includes a diaphragm 102 and an electro-magnetic motor 104 (FIGS. 1B & 1C) that drives motion of the diaphragm 102. The electro-magnetic motor 104 includes a magnetic circuit and a coil 106 that is mechanically coupled to the diaphragm 102 via a bobbin 108. The coil 106 (a/k/a “voice coil”) is a wire, usually copper or aluminum, through which an electrical audio signal flows. The flowing current of the audio signal alternates, creating an electromagnetic field which is opposed by a permanent magnetic field of the magnetic circuit. This causes the coil 106 and diaphragm 102 to move.

The speaker 100 may be a full range microdriver, e.g., having a diaphragm 102 less than 6 mm in diameter, e.g., between 3 mm and 5.5 mm in diameter, e.g., 4.3 mm to mm in diameter, such as those described in U.S. Pat. No. 9,942,662, titled “Electro-acoustic driver having compliant diaphragm with stiffening element,” and issued on Apr. 10, 2018, and/or U.S. Pat. No. 10,609,489, titled “Fabricating an integrated loudspeaker piston and suspension,” issued on Mar. 31, 2020, the complete disclosures of which are incorporated herein by reference. As used herein “full range” is intended to mean capable of producing frequencies from about 20 Hz to about 20 kHz. The speaker 100 may have an overall height (h) of about 3 mm to about 8 mm. The outer diameter (d) of the speaker 100 may be between about 3.0 mm and 4.5 mm, between about 3.3 mm and 4.2 mm, or between about 3.6 mm and 3.9 mm. A ratio of a radiating area of the speaker 100 to a total cross-sectional area of the speaker 100 may have a value of about 0.7, a value between about 0.57 and 0.7, a value between about 0.6 and 0.67 or a value between about 0.62 and 0.65.

The diaphragm 102 is suspended via a surround 110 which couples the diaphragm 102 to a frame 112. The surround 110 may be formed of liquid silicone rubber (LSR), e.g., 25 μm thick, 30 Shore A, LSR, and the frame 112 may be formed of nylon. The diaphragm 102 includes a piston 114, e.g., a nylon piston, that is coated with a layer of LSR, which may also be used to integrally form the surround 124. The piston 114 is mechanically coupled to the bobbin 108 via an adhesive 113. The frame 112 is mechanically coupled to an open end of a cup 116. A printed circuit board (PCB) 115 is provided at an outer surface of the bottom of the cup 116 and includes a pair of terminals 117 which are electrically connected to the coil 106, e.g., via wires 119, for providing an electrical audio signal thereto. The wires 119 run from the PCB 115 up the outer surface of the cup 116, pass through openings in the frame 112 and are attached to the coil 106.

The magnetic circuit includes a primary magnet 118 and a secondary magnet 120. A first surface of the primary magnet 118 is bonded to an inner surface of the cup 116 via a first adhesive 122 (e.g., a thermally accelerated adhesive). The primary magnet 118 and the secondary magnet 120 are bonded to each other via a coin 124. In that regard, a second, opposite surface of the primary magnet 118 is bonded to a first side of the coin 124 via a second adhesive 126 (e.g., a thermally accelerated adhesive), and a second, opposite side of the coin 124 is bonded to a first surface of the secondary magnet 120 via a third adhesive 128 (e.g., thermally accelerated adhesive). In some cases, the first, second, and third adhesives may be the same thermally accelerated adhesive material. The cup 116, the coin 124, and the primary and secondary magnets 118, 120 collectively form the magnetic circuit. The cup 116 and the coin 124 are each formed of a magnetically permeable material, such as iron or stainless steel, e.g., 430 stainless steel. The magnets 118, 120 are arranged such their respective magnetic fields are oriented opposite each other (i.e., their magnetic fields are reversed relative to each other).

Both the primary and secondary magnets 110, 112 are Rare earth-Iron-Boron (REFeB) magnets that are processed with a grain boundary diffusion (GBD) process as described below. The primary magnet 110 has a diameter of about 1.5 mm to about 3 mm, e.g., 2.20 mm, and a thickness of about 1.5 mm to about 3 mm, e.g., 2.00 mm. The primary magnet 110 has a surface area of about 10 mm\hat{ }2 to about 450 mm\hat{ }2, e.g., 21.43 mm\hat{ }2, a volume of about 2.5 mm\hat{ }3 to about 353 mm\hat{ }3, e.g., 7.60 mm\hat{ }3, and a surface area to volume ratio (SA:V) of about 2 mm\hat{ }−1 to about 8 mm\hat{ }−1, e.g., about 2.82 mm\hat{ }1.

The secondary magnet 112 has a diameter of about 0.5 mm to about 15 mm, e.g., 2.20 mm, and a thickness of about 0.5 mm to about 3 mm, e.g., about 0.50 mm. The secondary magnet 112 has a surface area of about 6 mm\hat{ }2 to about 450 mm\hat{ }2, e.g., 11.06 mm\hat{ }2, a volume of about 2 mm\hat{ }3 to about 350 mm\hat{ }3, e.g., 1.90 mm\hat{ }3, and a surface area to volume ratio (SA:V) of about 3 mm\hat{ }−1 to about 8 mm\hat{ }−1, e.g., about 5.82 mm\hat{ }−1.

During assembly of the magnetic circuit, the first adhesive 122 is applied to the first surface of the primary magnet 118 and/or the inner surface of the cup 116 and the two components are joined together to form a first sub-assembly with a preliminary bond provided by the uncured first adhesive 122. The first subassembly is heated (e.g., to a temperature of about 80° C. to about 120° C., for a period of about 0.5 minutes to about 15 minutes) on a hot platen to cure the first adhesive 122.

Similarly, the third adhesive 128 is applied to the first surface of the secondary magnet 120 and/or the second side of the coin 124 and those two components are joined together to form a second sub-assembly with a preliminary bond provided by the uncured third adhesive 128. The second subassembly is heated (e.g., to a temperature of about 80° C. to about 120° C., for a period of about 0.5 minutes to about 15 minutes) on a hot platen to cure the third adhesive 122.

In some cases, the primary magnet 118 may be magnetized after the first adhesive is cured and/or the secondary magnet 120 may be magnetized after the third adhesive is cured to avoid heat related demagnetization.

Once the first and second sub-assemblies are formed and the first and third adhesives are cured, the second adhesive 126 is applied to the second surface of the primary magnet 118 and/or the first side of the coin 124 and those two sub-assemblies are joined together to form the magnetic circuit with a preliminary bond provided by the uncured second adhesive 126. Notably, both magnets must be magnetized before the two sub-assemblies are joined. The magnetic circuit is then placed in a fixture to hold the two sub-assemblies together. In that regard, because the primary and secondary magnets 118, 120 are arranged such that their magnetic fields are oriented opposite each other, they have a tendency to repel each other, and, thus, cause the first and second sub-assemblies to separate. The fixture is used to resist this separation and to hold the first and second sub-assemblies in alignment until the second adhesive 126 is cured. The magnetic circuit (and fixture) is then heated (e.g., to a temperature of about 80° C. to about 120° C., for a period of about 0.5 minutes to about 15 minutes) on a hot platen to cure the second adhesive 126. The bottom of the cup 116 is heated and the heat has to travel up through the primary magnet 118, through the coin 124, so that it can form the final bond of the first sub-assembly to the second sub-assembly. The primary and secondary magnets 118, 120 are resisting each other during this whole process. Then, that step is followed by an oven bake (e.g., to a temperature of about 80° C. to about 120° C., for a period of about 0.5 minutes to about 15 minutes).

Over time, the hot platen processes get worse because the platen itself will start to get scratched which interferes with ability to transfer heat. That means, to maintain cycle times, the heat may need to be increased. The higher the oven temperature the shorter the required cycle time. It was discovered that this heating of the magnetic circuit assembly was causing demagnetization of the magnets 118, 120, which reduced the motor strength. The reduction in motor strength caused a drop in the broadband sensitivity of the driver, which, in turn, takes a toll on battery life—i.e., weaker motors require more power consumption for the same output.

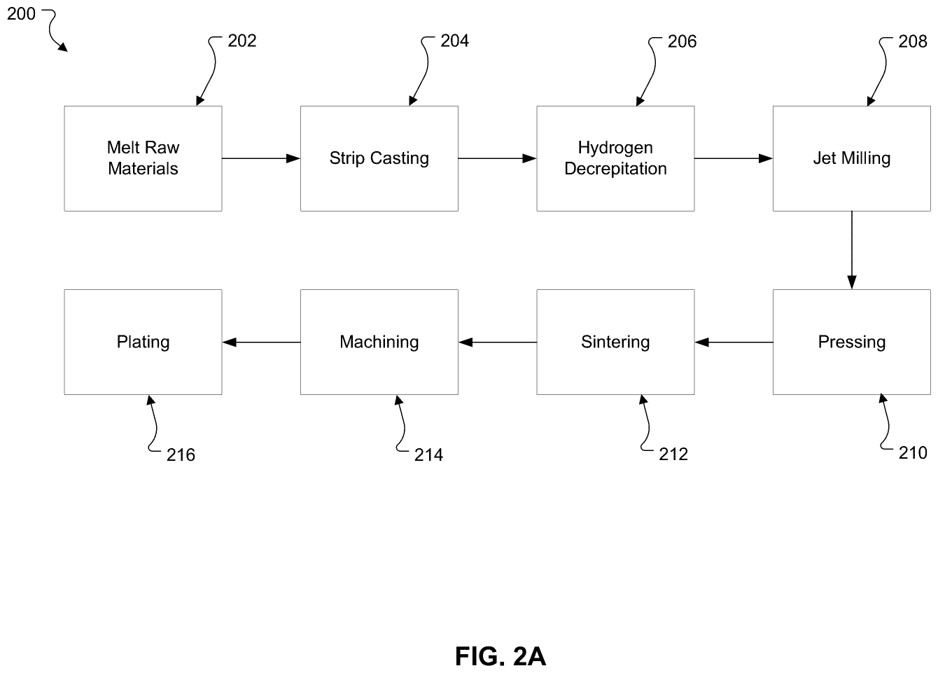

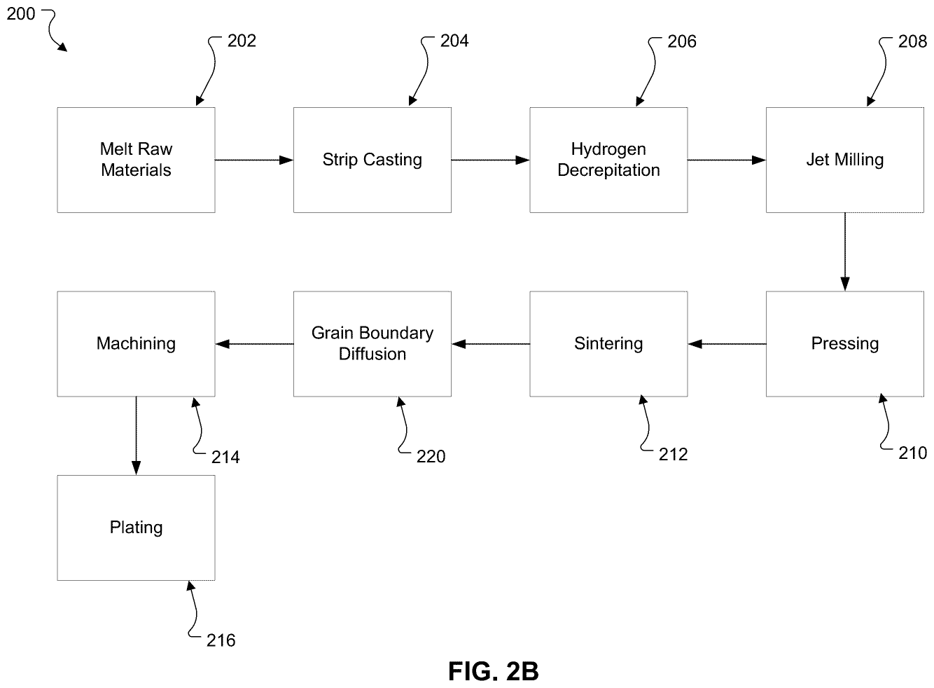

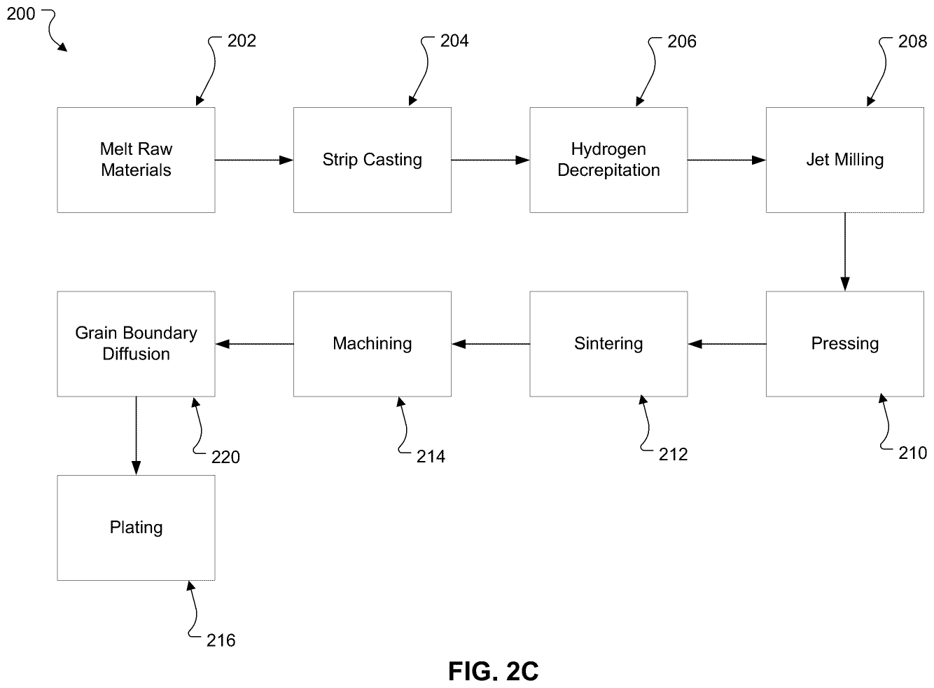

FIG. 2A illustrates a traditional manufacturing process 200 for magnets. The process begins with a mixture of raw materials being melted 202 in a melting vacuum furnace. The mixture is a precise composition of Neodymium and Praseodymium (“NdPr”), other rare earths, Iron, Boron and often small amounts of cobalt and transition metals. All constituent materials are weighed very precisely and deposited into the melting pot in small batches. The melted mixture is then poured onto a cooled spinning drum in a process called strip casting 204. What comes off of the drum are fragile pieces of composite magnetic material. Hydrogen decrepitation 206 is the used to break up the strip cast pieces. Then a jet milling process 208 is used to create a fine powder. The powder is pressed 210, in an orienting magnetic field, to form fragile blocks. Those blocks are then put through a sintering process 212 during which the blocks shrink and densify into a solid block. The densified blocks can then be machined 214 to form and then plated 216. Such magnets are referred to herein as Rare earth-Iron-Boron (“REFeB”) magnets.

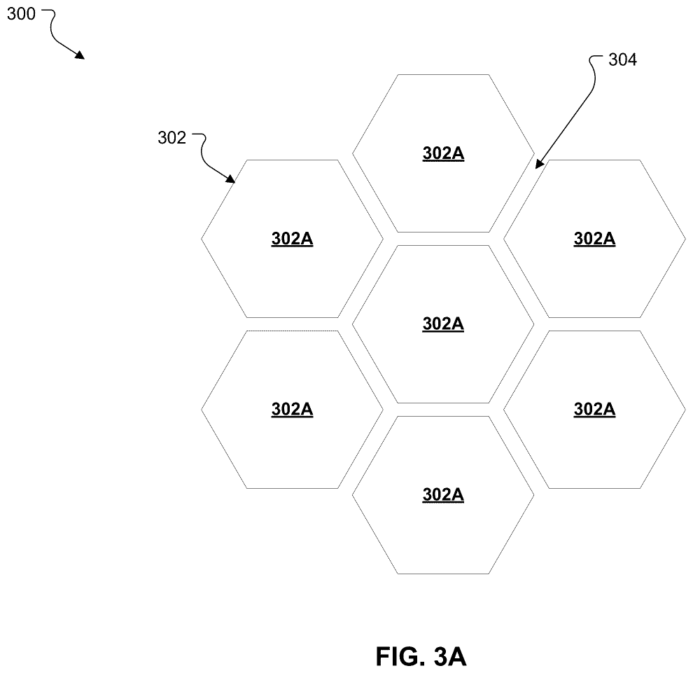

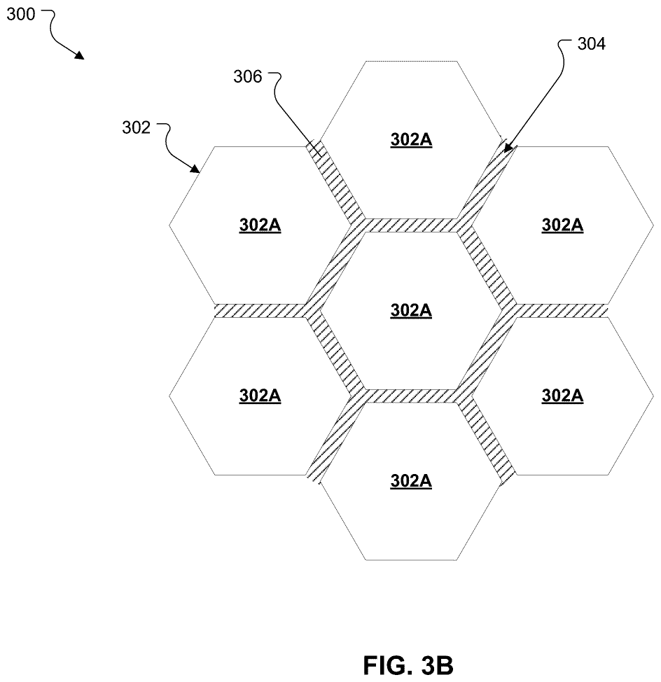

FIG. 3A is a schematic representation of the microstructure 300 of a REFeB magnet formed using the process of FIG. 2A. The REFeB magnet includes a rare earth, Iron and Boron phase 302 (a/k/a “major phase”) and a rich rare earth phase 304. The rich rare earth phase 304 is distributed around the major phase 302 and is referred to as the grain boundary rich rare earth phase, or simply “grain boundary.”

Magnets typically have two opposing properties. One of them is the strength of the magnet and the other is its resistance to demagnetize in use. The reason these are competing properties is because when the parameters are set for the strip casting and later for the sintering those parameters are going to determine a lot about the grain size of the final magnet. In the past, the grains were made bigger for greater strength. But, in order to have resistance to demagnetization, the grains often had to be made smaller. Basically, demagnetization ripples through the magnet and the grain boundaries between the grains act as sort of a firewall to demagnetization. And, the more grain boundary, the more firewall to demagnetization.

Previously, heavy rare earths (Dysprosium (Dy) or Terbium (Tb)) were added to the melt (step 202, FIG. 2A) to reduce sensitivity to heat demagnetization. The problem with that process is the heavy rare earth winds up in the main grain as well as in the grain boundaries, when it is really only desirable to have it in the boundaries. If it winds up in the main grain, it actually weakens the cold magnet strength.

GBD improved upon this process by applying a heavy rare earth element (e.g., Dy or Tb) after the block is formed (step 220, FIG. 2B), which may be after machining (step 220, FIG. 2C). There are various processes for performing GBD, including physical vapor deposition (PVD) magnetron sputtering, spray coating, and rotated diffusion, but they all generally consist of depositing the heavy rare earth on the surface of the magnet and then applying heat to cause diffusion of the heavy rare earth material into the magnet. With the GBD process, the distribution of the heavy rare earth 306 is limited to the grain boundaries, as illustrated in FIG. 3B. This increases the coercivity of the magnet, which is then less susceptible to demagnetization caused by high temperatures and machining and/or plating operations. Importantly, GBD reduces the magnets sensitivity to heat without significantly reducing its motor strength.

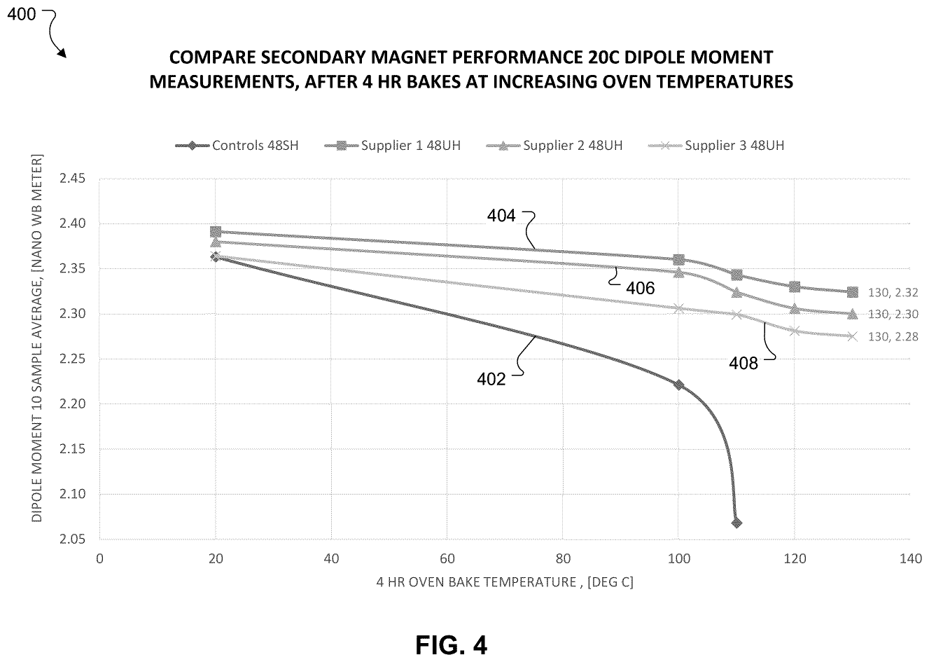

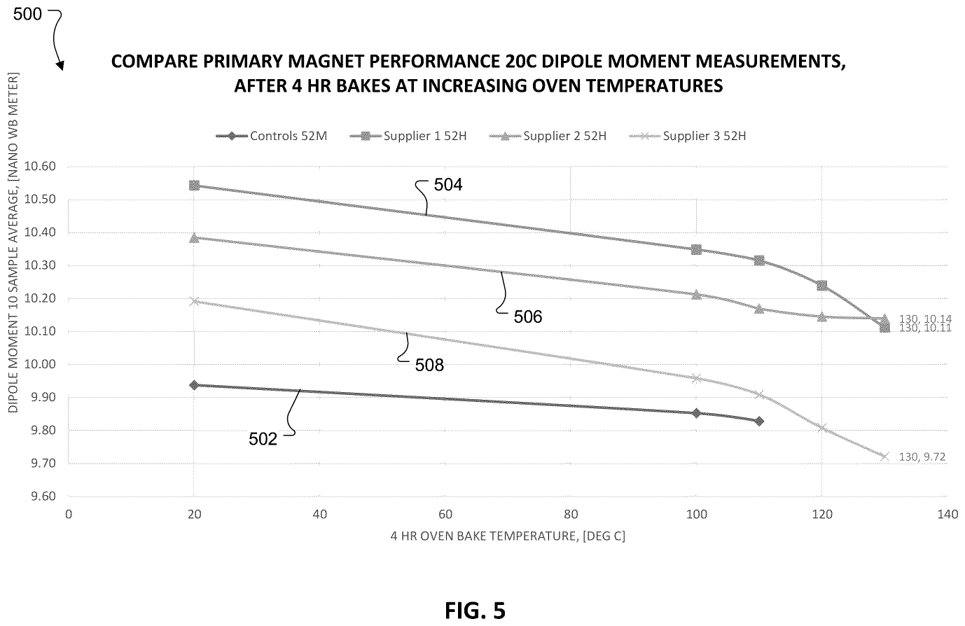

Three different suppliers of grain boundary diffusion magnets were approached to apply the technology that was developed for engine magnets to tiny magnets—none had previously applied grain boundary diffusion on such tiny magnets as cited in this document's specific primary and secondary magnet dimensions. The results are shown in FIGS. 4 and 5. FIG. 4 shows a plot 400 of dipole moment measurements over temperature for four (4) different versions of the secondary magnet 120. Curve 402 represents the results for the unmodified (control) secondary magnet. Curve 404 represents the results for a GBD modified version of the secondary magnet from a first supplier, curve 406 represents the results for a GBD modified version of the second magnet from a second supplier, and curve 408 represents the results for a GBD modified version of the second magnet from a second supplier. All curves represent an average of ten samples. By way of comparison, it can be seen that the thermal stability and starting dipole moments of all the GBD modified magnets is better than that of the control magnets.

Without GBD, the secondary magnet 120 was limited to a maximum energy product (BHmax) of 35 MGOe and a coercivity (HCJ) grade of SH. With GBD, the secondary magnet 120 is able to achieve a BHmax of at least 48 MGOe and an HCJ grade of UH.

FIG. 5 is a similar plot 500 that compares an unmodified (control) primary magnet (curve 502) to GBD modified primary magnets from the three suppliers (curves 504, 506, and 508, respectively)—all curves 502, 504, 506, 508 representing an average of ten samples. Once again, the starting dipole moments of all the GBD modified magnets are better than the control magnets.

Without GBD, the primary magnet 118 was limited to a BHmax of 48 and an HCJ grade of EH. With GBD, the primary magnet 118 is able to achieve a BHmax of at least 52 MGOe and an HCJ grade of SH. Also, the control magnets underperformed at room temperature due “small magnet syndrome”.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. For example, while implementation including disc magnets have been described above, alternative magnet shapes are also contemplated including rings, bars, arcs or any other shape. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An electro-acoustic transducer comprising:
a diaphragm; and
an electro-magnetic motor for driving motion of the diaphragm,
wherein the electro-magnetic motor comprises a magnetic circuit comprising a first Rare earth-Iron-Boron (REFeB) magnet that comprises a major phase and a grain boundary rich rare earth phase, and
wherein a heavy rare earth element (HREE) is diffused into the first REFeB magnet through the grain boundary rich rare earth phase.

2. The electro-acoustic transducer of claim 1, wherein the heavy rare earth element is selected from the group consisting of: Dysprosium (Dy) and Terbium (Tb).

3. The electro-acoustic transducer of claim 1, wherein the first REFeB magnet comprises one or more light rare earth elements selected from a group consisting of Cerium (Ce), Neodymium (Nd) and Praseodymium (Pr).

4. The electro-acoustic transducer of claim 1, wherein the major phase comprises a plurality of grains and wherein the grains are substantially free of the HREE.

5. The electro-acoustic transducer of claim 1, wherein the magnetic circuit further comprises a second REFeB magnet that comprises a major phase and a grain boundary rich rare earth phase, and wherein a HREE is diffused into the second REFeB magnet through the grain boundary rich rare earth phase of the second REFeB magnet.

6. The electro-acoustic transducer of claim 5, wherein the magnetic circuit comprises:
a steel cup within which the first REFeB magnet is disposed; and
a steel coin disposed between the first REFeB magnet and the second REFeB magnet.

7. The electro-acoustic transducer of claim 6, wherein the first REFeB magnet is bonded to the steel cup with a first adhesive,
wherein the second REFeB magnet is bonded to the steel coin with a second adhesive, and
wherein the steel coin is bonded to the first REFeB magnet with a third adhesive.

8. The electro-acoustic transducer of claim 6, wherein a first surface of the first REFeB magnet is bonded to the steel cup; and
wherein a second surface of the first REFeB magnet, opposite the first surface, is bonded to the steel coin.

9. The electro-acoustic transducer of claim 8, wherein the first REFeB magnet and the second REFeB magnet are bonded to opposite sides of the steel coin.

10. The electro-acoustic transducer of claim 9, wherein the first REFeB magnet and the second REFeB magnet are arranged such that their magnetic fields are oriented opposite each other.

11. The electro-acoustic transducer of claim 5, wherein the second REFeB magnet has a surface area to volume ration (SA:V) of about 1 mm\hat{ }-1 to about 8 mm-1.

12. The electro-acoustic transducer of claim 1, wherein the first REFeB magnet has a surface area to volume ration (SA:V) of about 1 mm-1 to about 8 mm-1.

13. The electro-acoustic transducer of claim 1, wherein the electro-acoustic transducer has an overall diameter of about 3 mm and about 16 mm.

14. The electro-acoustic transducer of claim 1, wherein the diaphragm has a diameter of about 3 mm and about 16 mm.

15. The electro-acoustic transducer of claim 1, wherein the first REFeB magnet comprises a Neodymium-Iron-Boron (NeFeB) magnet or a Cerium-Iron Boron (CeNdFeB) magnet.
